(19) United States
(12) Patent Application Publication
(10) Pub. No.: US 2014/0259412 A1
(43) Pub. Date: Sep. 18, 2014

(54) PATIENT SUPPORT

(71) Applicant: Stryker Corporation, Kalamazoo, MI (US)

(72) Inventors: Jeffrey C. Shiery, East Leroy, MI (US); Christopher Gentile, Sturgis, MI (US); Corey Hoffman, Vicksburg, MI (US); Jerry Allen Wheeler, Augusta, MI (US); Christopher S. Hough, Kalamazoo, MI (US); John P. Zerbel, Paw Paw, MI (US); Nathan M. Stewart, Portage, MI (US); Christopher Ryan Sweeney, Portage, MI (US)

(73) Assignee: Stryker Corporation, Kalamazoo, MI (US)

(21) Appl. No.: 14/205,500

(22) Filed: Mar. 12, 2014

Related U.S. Application Data
(60) Provisional application No. 61/788,848, filed on Mar. 15, 2013.

(51) Int. Cl. A61G 7/012; A61G 7/08

(52) U.S. Cl. CPC A61G 7/012; A61G 7/08
USPC 5/611; 5/510

(57) ABSTRACT

A compact patient support provides a full range of motion and function while optimizing compactness and achieving an improved “low height” position. Casters joined to the base of the support have a low profile and provide mechanical braking about a swivel axis and a rotational axis of the wheels. The low profile of the casters allows for a more compact base. The lift mechanism includes a lift actuator with the motor mounted on the upper of two stacked X-frames allowing for shorter cables and harnesses and allowing for a more compact folding of the X-frames when the support is in a lowered position thereby reducing bulk and contributing to the overall compactness of the patient support.

### BACKGROUND OF THE INVENTION

The present invention relates to a patient support such as a bed, stretcher, cot, or similar support suitable for transporting a patient from one location to another in an environment such as a hospital, urgent care facility, nursing home or long term care facility, etc.

When transporting a patient from one location to another on a patient support it is known to provide wheels to conveniently roll the support from place to place. The wheels are further known to rotate, such as axially from a wheel stem, allowing a user to turn, reverse direction or otherwise guide the patient support while in transit.

In addition to providing rolling movement for a patient support, generally such supports are capable of being lowered to a reduced height to allow easy movement of a patient into or out of the support and then raised to a taller height for transport or for monitoring or examination of the patient by a medical professional. Lifting mechanisms that provide the vertical adjustment are known to be bulky and have a limited vertical travel range. However, most lifting mechanisms have limited ability to lower the deck of the support to what is regarded as a “low height position” where the deck is so close to the ground that most patients cannot exit a bed, which is desirable with some patients.

Further, most lifting mechanisms that involve linkages, tend to shift the deck horizontally when raising or lowering the bed. This shifting can be problematic when the patient support is in confined spaces, such as in elevators, where the deck may bump or squeeze the caregiver or other people in the elevator if the deck needs to be lowered, such as in an emergency.

### SUMMARY OF THE INVENTION

Accordingly, the present invention provides an improved lifting mechanism that can provide increased range of motion between its fully raised and its fully lowered position, and further may allow the deck to be lowered to a low height where most patients cannot exit the bed. Additionally, the lifting mechanism may be configured such that the deck does not shift horizontally when raising or lowering the bed.

One embodiment provides a patient support with a deck, a substantially horizontal base supporting the deck, and a braking mechanism. The braking mechanism has at least one caster joined to the base. The caster includes a caster wheel to facilitate rolling movement of the support and has a substantially vertical swivel axis and substantially horizontal rolling axis. At least one brake link is supported by the base and is coupled to a linear actuator that is operable to brake the caster wheel about both its swivel axis and its rotational axis.

In one aspect, the patient support further includes a brake rod that extends transversely across the base and rotates about a brake rod axis.

In another aspect, the linear actuator includes two actuating members, one member for causing said caster wheel to brake about its swivel axis, and the other member for causing said caster wheel to brake about its rotational axis.

In a further embodiment, any one of the foregoing embodiments may further provide a deck and a lifting mechanism. The lifting mechanism has an upper component and a lower component. A lifting actuator is joined to the upper component.

Any one of the above described embodiments may also provide upper and lower components as X-frames. Further aspects of the foregoing embodiments may include the deck having a range of vertical movement above the floor or ground between an upper deck height and a lower deck height where the lower deck height is less than about 14 inches above the floor. The lower deck height may also be less than about 13 inches above the floor. Or the lower deck height may be about 12 inches above the floor.

Another embodiment of the invention provides a patient support with a deck and a lifting mechanism having an upper end coupled to the deck and a lower end supported by the base. The lifting mechanism has an upper component and a lower component with a lifting actuator joined to the upper component.

The foregoing embodiment may also include an upper X-frame as an upper component and a lower X-frame as a lower component wherein the upper X-frame is stacked over and interconnected to the lower X-frame.

The patient support of the foregoing embodiments may also have a frame of the deck with slots therein, and a plurality of rollers coupled to the upper end and the lower end of the lifting mechanism. The rollers at least partially transverse the slots.

Further, the patient support of the foregoing embodiment may have the deck with a range of vertical movement between an upper deck height above a floor and a lower deck height above the floor. The rollers travel within the slots as said deck moves with said range of vertical movement.

Another aspect of the invention allows travel of the rollers within to slots maintain the deck in a substantially horizontal position during a change of vertical position of the deck over the range of vertical movement.

A further aspect of any of the foregoing embodiments includes an upper stabilizing member having a first end joined to the frame of the deck and a second end joined to the upper component and a lower stabilizing member having a first end joined to the lower base of the lifting mechanism and a second end joined to the lower component.

Another aspect of the embodiment provides the lower deck height at less than about 14 inches. Further, the low deck height is less than about 13 inches above the floor. The low deck height may also be provided at about 12 inches above the floor.

Any of the foregoing embodiments may also provide at least one caster joined to the base, the caster having a substantially vertical swivel axis, and a wheel on each caster to facilitate rolling movement of the support. The caster also has at least one brake link supported by the base and coupled to a linear actuator operable to provide mechanical braking to the wheel of said rolling movement and the caster of said swivel.

Further the above embodiments may include at least two actuating members, a first member causing the caster to brake about the swivel axis and a second member causing the wheel to brake about a rotational axis about which the wheel rotates.

These and other objects, advantages, and features of the invention will be more fully understood and appreciated by reference to the description of the current embodiment and the drawings.

### BRIEF DESCRIPTION OF THE DRAWINGS

FIG. 1 is a perspective view of a patient support.

FIG. 2 is an exploded view of a frame and brake components of a patient support.

FIG. 3A is a perspective view of a frame, brake components and casters of a patient support.

FIG. 3B is a detailed view of brake components for the support.

FIG. 4 is an exploded view of a caster for use with the patient support.

FIG. 5 is a cross-sectional view of a caster in a “brake off” position.

FIG. 6 is a cross-sectional view of a caster in a “brake on” position.

FIG. 7 is a perspective view of a lifting mechanism for the patient support.

FIG. 8 is a front view of the lifting mechanism of FIG. 7.

FIG. 9 is a side view of the lifting mechanism of FIG. 7.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and may be practiced or carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### DESCRIPTION OF THE CURRENT EMBODIMENT

Referring to FIG. 1, a patient support, generally designated as 10, is illustrated as a bed, such as a med/surge bed or ICU bed, but the patient support 10 may be configured as a stretcher, cot or other device suitable for use in a hospital facility, outpatient clinic, urgent care facility, nursing home, or long term care facility. The support includes a base 12 and a deck 14. A lifting mechanism 16 provides support for the deck 14 from the base 12 and allows the height of the deck 14 to be adjusted up and/or down. The deck 14 supports a mattress 18 upon which a patient may rest or be placed.

The patient support 10 described herein provides a full range of motion and function while optimizing compactness and achieving an improved “low height” position. Several components of the patient support 10 combine to contribute to the overall height of the support 10. These components includes a vertical layering, or stack, of items including the mattress 18, deck 14, lift mechanism 16, and base 12, but is not limited to these components. Casters 100, as shown in FIG. 3A and described herein have a low profile relative to alternative wheel choices. This low profile allows for a more compact base 12. The lift mechanism, as illustrated in FIGS. 7-9, includes a lift actuator 250 with a motor mounted on an upper link of two stacked X-frames allowing for shorter cables and harnesses and allowing for a more compact folding of the X-frames when the support is in a lowered position thereby reducing bulk and contributing to the overall compactness of the support 10. The support 10 may be lowered to a height of less than 14 inches, preferably less than 13 inches and most preferably about 12 inches above the floor or ground.

The base 12, as seen in FIG. 3A includes casters 100 at one or more corners 22 of the base 12. The casters 100 have an actuator receiver 24 to which the frame members 27, 29 of the base 12 are connected. The actuator receiver 24 may be covered with a cap 26. Each caster 100 includes a caster wheel 110, as shown in FIG. 4, that swivels as well as rotates. The swivel and/or rotating actions are braked by a brake assembly described below.

The braking assembly provides mechanical braking of the caster rather than relying upon a friction brake such as those with a drum or disc and shoe/brake pad. The mechanical braking assembly includes a brake rod 28 that extends transversely across the base 12. Optionally, the brake rod 28 may transverse the width of the base 12 from one side bar 29 to the other. The brake rod 28 is mounted to the base 12 by a pair of support plates 30. The support plates 30 are attached to the side bars 29 and optionally secured to the outside surfaces of side bars 29 of the base 12 and may also be reinforced by a cross bar 32 of the base 12.

As shown in FIGS. 2-4, each support plate 30 includes a hole 31 through which the brake rod 28 fits on sides of the base 12. To transfer motion from the brake rod 28 to the caster wheels 110, the brake system further includes a pair of links on each side of the base 12, with one set of links for actuating casters 100 on one side of the base 12 and the other set activating the caster 100 on the other side of the base 12. In addition to transferring motion from the brake rod 28 to the respective links, each end of the brake rod 28 supports a linkage plate 34. The linkage plates 34 each include a hole through which the brake rod 28 is inserted. The plate 34 includes connection points 36 to connect a first, optionally shorter, brake link 38 and a second, optionally longer, brake link 39. Referring again to FIG. 2, the plate 34 and brake links 38, 39 may be located on the inside of base members 27, 29 of the base 12. However, it should be understood that a single set of brake links 38, 39 may be used with the caster wheels 110 on the outside side of the base 12, opposite the position indicated in FIG. 3A, and activated by similar linkages located at or near the ends of the base 12.

Mounted to the ends of the brake rod 28 are foot pedals 33, which when pressed on either end induce rotation of the brake rod 28. To provide resistance to the rotation of the brake rod 28 and to provide user recognizable positions, the plate is configured to define a braked position and an unbraked position. For example the plate 34 may be held in position by a detent mechanism 40. The detent mechanism 40 is roller mounted to the side bar 29 of the base 12. A finger 42 of the detent mechanism 40 engages one of several dentations 44 in the plate 34. The brake rod 28 and brake links 38, 39 are therefore held in one of its defined positions by the detent mechanism 40. In order to rotate the brake rod 28, sufficient force needs to be applied to the pedal 33 to cause the detent mechanism 40 to disengage from the detentations 44. The ends of one or both of the brake links 38, 39 are connected to a linear actuator which is simply referred to as actuator 120 (discussed in detail below).

Referring to FIGS. 4-6, the casters 100 each includes wheel 110. Each wheel 110 is mounted about a wheel shaft 112 which also supports a wheel gear 114 with the wheel 110 for conjoint rotation with the wheel 110. In the illustrated embodiment, the caster 100 includes two wheels 110 mounted to wheel shaft 112 on either side of the wheel gear 114. Wheels 110 and wheel gear 114 are mounted in a gear housing 116 which includes two spaced apart support walls 118 and a bracket 119. The caster 100 is assembled with the wheel gear 114, shaft 112, support walls 118 to thereby support wheels 110 and gear 114. The support walls 118 include a pair of flanges 118a into which is mounted an actuator housing 130. In the embodiment of FIGS. 4-6, the actuator housing 130 includes an upper end 134 that at least partially extends beyond the flanges 118a of the gear housing 116. At least a portion of the upper end 134 of the actuator housing 130 is splined to couple an anti-swivel gear 132 to the actuator housing 130. When mounted between support walls 118, the anti-swivel gear 132 is located above flanges 118a of the support walls 118 for access by the lock pin 178 discussed later. Alternatively, the upper end 134 of the actuator housing 130 and the anti-swivel gear 132 may be keyed to fit together to facilitate rotational movement about axis A.

Actuator housing 130 includes a passage 133 for receiving an actuation pin 136 and a shoulder to support an anti-swivel gear 132. The actuation pin 136 extends into the passage 133 and is coupled to a lever 140 for triggering the stopping of the wheel gear 114. Lever 140 is coupled to the lower end for actuation pin 136 by a latch pin 144 that extends into the passage 133 through a slot formed in the housing 130.

Referring to FIG. 4, the lever 140 may include a pair of lever arms 142 that extend in between support walls 118 to engage gear 114. Lever arms 142 may be supported on one end by flanges 118a and housing 130. The lever 140 has a pivot point at a fulcrum pin or pivot pin 146 attached through the support wall 118 of the gear housing 116. The lever 140 includes a retaining pin or locking pin 148 fitted into a slot 149 of the gear housing 116. The gear 114, gear housing 116, support wall 118, bracket 119 and a portion of the actuator housing 130 are surrounded by a cover. The upper end 134 of the actuator housing 130 and the anti-swivel gear 132 extend outside the cover 150, 152. In FIGS. 4-6, the cover is a two-part cover including an actuator housing cover 150 and a gear cover 152.

As shown in the FIGS. 1 and 2, the caster 100 may form the corners 22 for the base 12. However, the caster 100 may be mounted to the base 12 with side bars 29 and end bars 27 forming a frame to which the casters 100 may be mounted. Coupling between the actuator receiver 24 and the caster 100 may be by compression fit of the components 24, 100 or by other known fastening means. In FIGS. 4-6 a bearing 156 around the upper end 134 of the actuator housing 130 couples the caster 100 to the actuator receiver 24. A flanged washer 157 and lock nut 158 further secure the upper end 134 of the actuator housing 130 to the actuator receiver 24 of the caster 100. This configuration leaves the anti-swivel gear 132 below the base 12 and actuator receiver 24 of the caster 100. The bearing 156 allows the caster 100 to rotate around axis A of the actuation pin 136. The rotation allows the wheels 110 of the caster 100 to pivot through a 360 degree range so that the support 10 can be guided in a desired direction while it is rolling.

The actuator receiver 24 is fitted with a cap 26 with one or more raised portions or rails 25 on the underside of the cap 26. A top side of the actuator receiver 24 and the rails 25 of the cap 26 fit together to define a channel 126. The actuator 120 has a top portion 170 with an extended arm 122 that slides within the channel 126. On an end of the actuator 120 opposite the extended arm 122, the actuator 120 is coupled to one of the brake links 38, 39. The extended arm 122 includes a cutout or depression 160 with a ramp 162 on one end and a wall 164 on the other end and a ceiling 166. The depression 160 is in a surface of the extended arm 122 of the actuator 120 facing the upper end 134 of the actuator housing 130 and the actuation pin 136. The actuator top portion 170 may be fitted over the side bar 29 of the base 12 and a bottom portion 172 may be connected to the top portion 170 from under the side bar 29 such that the side bar 29 is sandwiched between the top portion 170 and bottom portion 172 of the actuator 120. The bottom portion 170 of the actuator 120 has a passage or channel 176 through it that is oriented in a direction substantially parallel to the longitudinal orientation of the extended arm 122. A lock pin 178 is fitted into the channel 176 and at least partially extends outside the bottom portion 172 of the actuator 120. As best seen in FIGS. 3A and 4, the actuator 120 includes a link plate 174 that facilitates connection between the actuator 120 and the brake links 38, 39.

FIGS. 7-9 depict a lifting mechanism for the patient support 10, which is generally designated 200. The lifting mechanism 200 includes a lower housing 210 with a bottom bracket 211 having flanges 212. The deck 214 is raised and lowered by two stacked and interconnected components, a lower component such as a lower X-frame 220 and an upper component such as an upper X-frame 240. The lower housing 210 provides support for the lower X-frame 220 and, when the lift mechanism is in a collapsed or lowered position, the lower housing 210 may contain all or most of the X-frame 220, 240 members and the lifting actuator 250. Flanges 212 on the lower housing 210 may be used to support the deck 214 when the lifting mechanism is in its extreme lowered position or may be used as a surface to align and attach to the base 12 of the support 10 such as those shown in FIGS. 1-3B.

The extreme ends 225, 227, 243, 249 of the support links, such as X-frame members 222, 224, 242, 244, are coupled to rollers 230, 256. During raising and lowering of the lift mechanism 200, each roller 230, 256 may roll within slots 234, 254 in the lower housing 210 or in a top bracket 215. The deck 214 is prevented from moving in a horizontal direction by upper stabilizing member 262 which serves to prevent the deck 214 from moving horizontally. A lower stabilizing member 236 connects one of the bottom support links, such as 224, to the bottom bracket 211. In the illustrated embodiment, the bottom support links 222, 224 may translate relative to the bottom bracket 211, while the lower stabilizing member 236 may not translate relative to the bottom bracket 211. Thus, the bottom support links 222, 224 may rotate and collapse while remaining centered with the bottom bracket 211. The upper stabilizing member 262 connects one of the top support links 244 to the top bracket 215. The top support links 242 and 244 may translate relative to the top bracket 215, but the upper stabilizing member 262 may not translate relative to the top bracket 215. Thus the top support links 242, 244 may rotate and collapse while remaining centered with the top bracket 215. For example if a caregiver should directly bump the deck or guide the end of the support 10 such that the deck is impacted, the deck will be prevented from horizontal shifting by the stabilizing members 262. Similarly, movement of the lower housing 210 within the horizontal plane, or away from a substantially horizontal orientation, is inhibited by lower stabilizing member 236.

The top bracket 215, in addition to providing slots 254 for rollers 256, may house harnesses, electrical connections, medical device components and the like. In conventional patient support devices, the amount and position of this equipment under the deck and the placement of the lifting actuator prevent the deck from being lowered to an optimum position for some preferences or activities. The lift mechanism 200 configuration shown in FIGS. 7-9 includes the lifting actuator 250, which generally may be a motor to drive a cylinder 251, mounted on the upper X-frame 240 members. A body 253 of the actuator 250 may be mounted on a cross bar within the upper X-frame 240 and allows the use of shorter power or data cables and the like between the lifting actuator 250 and any power source or device mounted under the deck 214. The actuator 250 is located between the two sets of support links 222, 224, 242, 244 in order to efficiently drive both sets of links simultaneously. The position of the actuator 250 relative to the support links also allows the actuator 250 and support links 222, 224, 242, 244 to be packaged efficiently. One end of the actuator 250 is pivotally mounted to the bottom bracket 211 by, for example, a mounting bracket 270, as shown in FIG. 8, at a location lower than the bottom support links 222, 224 in order to decrease the load on the actuator 250 when the mechanism is collapsed or lowered. This arrangement contributes to the overall range of vertical movement of the deck 214 by at least three mechanisms. First, any cables, power cords or like that would be required to connect to the lifting actuator 250 from below the deck 214 could have shorter lengths of cords, cables, etc. thereby reducing a need to store longer cables or cords and reducing the amount of cable or cord length that is required to travel the range of vertical movement by the deck 214. Second, the lifting actuator 250, by virtue of its position on the upper X-frame 240 is supported above the floor of the base housing 210 in a compact, collapsed or most lowered position and will not impede the closing together of the top bracket 215 and the lower housing 210. Third, the cylinder 251 may be provided in a longer length as the mounting on the upper X-frame 240 provides space for a greater stretch of the cylinder 251.

Both the lower X-frame 220 and the upper X-frame 240 include two sets of support links such as support links 222, 224, 242, 244. The two sets of links may be spaced apart and parallel for stability. The two sets of links may be connected in multiple locations to provide additional stability. The support links 222, 224 of the lower X-frame pivot at a central point 226 and the members 242, 244 of the upper X-frame pivot at a central point 246. The lower support links 222, 224 have top 223, 229 and bottom 225, 227 ends. As discussed above, the bottom ends 225, 227 are affixed with rollers 230 by fasteners 232. The bottom ends 225, 227 of the support links 222, 224 are arranged on the inside of the bottom bracket 211. The fasteners 232 transverse a slot 234 in the bottom bracket 211 to retain rollers 230 on the outside of the bottom bracket 211. A lower stabilizing member 236 is pivotally attached to both the bottom bracket 211 and a member 224 of the X-frame 220 at a pivot point 226a as shown in FIG. 8.

The upper X-frame 240 includes parallel members 244 with a widened area or wing 255. The wing 255 accommodates a dowel or rod 265 upon which a bushing 257 and an annular extension 259 of the lifting actuator 250 is mounted. The cylinder 251 of the actuator 250 extends to the floor of lower housing 210 to define the height of the patient support 10 as the actuator 250 is controlled to draw the cylinder 251 in or out. Upper X-frame members 242, 244 have deck ends 243, 249 that are most closely located under the deck 214 when the lifting mechanism is in an extended position as seen in FIGS. 7-9. Lower ends 245, 247 of the upper X-frame members 242, 244 extend toward the vertical center of the lifting mechanism when the mechanism is extended and are pivotally connected to the top ends 223, 229 of the support links 222, 224 of the lower X-frame 220. The deck ends 243, 249 of the upper X-frame 240 members 242, 244 are arranged on the inside of top bracket 215. Slots 254 in top bracket 215 receive rollers 256 that are attached to the deck ends 243, 249 of the members 242, 244. The upper stabilizing member 262 is pivotally attached to both the top bracket 215 and a member 244 of the upper X-frame 240 at a pivot point 246a as shown in FIG. 8.

In addition to the upper and lower stabilizing members 262, 236, one or more cross bars can be included to tie together or connect parallel members of the X-frames 220, 240. In the illustrated embodiment, cross bars 260, 261 provide additional stabilization between parallel members. In FIG. 7, two cross bars 260 are shown between parallel members 224 of the lower X-frame 220 and two cross bars 261 are shown between parallel members 242 of the upper X-frame 240.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In operation, the support 10 is used to transport a patient from one location to another by rolling the support 10 on the wheels 110. The support 10 may be guided to turn in any direction, as desired, by rotation or swivel of the caster 100 about axis A of the caster 100, anti-swivel gear 132 and actuation pin 136. To begin operation, the brake pedal 33, as shown in FIG. 2, is set in a “brake off” or unbraked position so that the finger 42 of detent mechanism 40 disengages the dentations 44 on the plate 34. The plate 34 and brake rod 28 are rotated in a clockwise direction as viewed in FIGS. 3A and 3B. The ends of the brake links 38, 39 connected to the plate 34 are pulled toward a center of the base 12 and away from the end bars 27. The opposite ends of the brake links 38, 39 that are attached to the actuators 120 similarly are pulled toward the center of the base 12 and place the actuator 120 in a corresponding “brake off” or unbraked position for the caster 100. Braking components may include cables rather than links 38, 39. However, over a period of several braking cycles, cables will have an opportunity or even a tendency to stretch potentially reducing brake performance to less than optimum. In the current embodiment, brake links 38, 39 are preferred over brake cables.

Referring to FIG. 5, in the “brake off” or unbraked position, the actuator 120 is positioned within the channel 126 of the caster 100 and the actuation pin 136 is biased in the passage 133 toward the upper end 134 of the actuator housing 130 and the extended arm 122 of the actuator 120. The bias of the actuation pin 136 toward the extended arm 122 may be accomplished by the force of the lever 140 acting through the latch pin 144, by a spring (not shown) within the actuator housing 130 beneath the actuation pin 136, or by providing an actuation pin that includes a self-contained spring loading, or by other known means. In the “brake off” position, the actuation pin 136 contacts the extended arm 122 of the actuator 120 in an area other than the portion of the extended arm 122 where the depression 160 is located. The lever 140 is positioned about the pivot pin 146 so that the retaining pin or locking pin 148 clears, or does not interfere with, the rotation of the wheel gear 114. The lever 140 is held in this position because the actuator pin 136 provides a downward force (as viewed in FIG. 5) on the latch pin 144 allowing the lever 140 to pivot about the pivot pin 146 and lift the locking pin 148 away from the gear 140.

To stop movement of patient support 10, a user may activate the brake pedal 33 to a “brake on” or braked position causing the brake rod 28 and plate 34 to rotate in a counterclockwise direction as viewed in FIGS. 3A and 3B. The brake links 38, 39 will be forced along the side bar 29 in a direction toward the end bars 27 of the base 12. The finger 42 of the detent mechanism 40 will engage a dentation 44 on the plate 34 to hold the brake shaft 28 in the braked position. The ends of the brake links 38, 39 opposite the plate 34 are connected to the actuator 120 and, when the brake pedal 33 is moved to its braked position, the actuator 120 move to facilitate a corresponding “brake on” position for the caster 100.

Referring to FIG. 6, when the brake pedal 33 (such as that shown in FIG. 2) is applied in the “brake on” mode, the extended arm 122 of the actuator 120 moves further into the channel 126. The depression 160 is shifted into a position above the actuator pin 136 allowing the actuation pin 136 to act on its bias upward and occupy the depression 160. The lever 140 pivots about the pivot pin 146 when the latch pin 144 is moved up (as viewed in FIG. 6) with the actuation pin 136. With the pivoting of the lever 140, the locking pin 148 engages the wheel gear 114 and terminates its rotation. Given that the wheel 110 and the wheel gear rotate conjointly about the wheel shaft 112, the wheel 110 will stop turning when the locking pin 148 engages the wheel gear 114. As the extended arm 122 of the actuator 120 moves further into the channel 126, the lock pin 178 in the bottom portion 172 of the actuator 120 will engage the anti-swivel gear 132 stopping the rotation, or swivel, of caster 100 about axis A. The extended arm 122 of the actuator 120 and the actuation pin 136 may be considered actuating members that act together to cause braking of the caster about its swivel axis and braking of the wheel 110 about its rotational axis.

The caster 100 may, when the brake pedal 33 is moved to the “brake on” position, stop the rotation of the wheel gear 114 and the anti-swivel gear 132 simultaneously or at different times in the braking process. For example, the depression 160 along the extended arm 122 may be designed with a longer ramp 162 or wider ceiling 166 which would allow the actuation pin 136 to activate the lever 140 causing braking of the wheel gear 114 before the lock pin 178 contacts the anti-rotation gear 132 when, or before a time when, the actuation pin contacts the wall 164 of the depression 160. Alternatively, the length of the lock pin 178 and the location of the depression 160 may be designed so that one or the other, or both are coupled to a solenoid that provides a delayed engagement of the lock pin 178 with the anti-swivel gear 132, or delayed engagement of the locking pin 148 of the lever 140 with the wheel gear 114.

To resume rotational movement of the caster 100 and allow the patient support 10 to be rolled and turned, the brake pedal 33 is returned to its “brake off” position. The brake rod 28, plate 34, and brake links 38, 39 move toward the center as described herein with respect to initiating operation of the support 10. As the brake links 38, 39 move toward the center of the base 12 and away from the end bars 27, the extended arm 122 of the actuator 120 retreats from the channel 126. The actuation pin 126 moves along the ramp 162 of the depression 160 and the caster 100 components return to the position shown in FIG. 5 as the “brake off” position.

In addition to transporting a patient from one location to another, the patient support 10 includes a lift mechanism 16 for raising and lowering the deck 14 and mattress 18 of the patient support 10. As shown in FIG. 1 the lift mechanism is generally mounted on the base 12 of the patient support 10 and under the deck 14 which supports a mattress 18. These mechanisms are useful for assisting patients into or out of the patient support 10. Frequently, due to the size or limited mobility of a patient, it is helpful to lower a bed, cot or other support to allow easier access or egress of patient from the patient support 10. In the case of allowing easier access to the support 10 by the patient, once the patient has entered the support, it frequently is desired to raise the height of the support 10 for transport or for patient monitoring or examination. Manipulation of the height of support may be accomplished manually. However, to provide smoother and more stable vertical movement of the deck electrically controlled actuators are beneficial.

Referring to FIGS. 7-9, a lifting actuator 250 is mounted on the upper X-frame 240 of a stacked, interconnected two X-frame mechanism 200. The stacked arrangement of the two frames allows the lift mechanism to be extended in a scissor-like fashion when the actuator 250 is engaged to lift the deck 214. The actuator 250 is operated electrically by a control system that includes a battery or DC power source or an external AC power source (not shown). The actuator 250 is of a type such as that described in U.S. Pat. No. 7,962,981, entitled HOSPITAL BED, which is incorporated by reference in its entirety herein and which is commonly owned by Stryker Corporation of Kalamazoo, Mich. Electrical wires, data cords or other wires and cords that connect the controller to the actuator from the power source (if external) and other cords such as data cords or harness straps are generally mounted under the deck 214 inside the top bracket 215.

The mounting of the actuator 250 on the upper X-frame 240 has the advantage of allowing a larger travel range of the actuator cylinder 251 thereby providing a larger range of vertical heights for the patient support 10. The larger travel range is accomplished by greater lift due to the elevated actuator 250 position allowing a longer actuator cylinder 251 to be accommodated in the lower housing 210 of the lifting mechanism 200. Also, in the lowered position the actuator 250 may avoid contacting the floor of the base 210 to allow the X-frames 220 and 240 to completely fold to provide a lowered patient support height of about 12 to 14 inches and preferably to about 12-13 inches and most preferable to about 12 inches. The lift mechanism can accommodate a vertical travel range of approximately 18 inches, for a patient support height from about 12 to about 30 inches. The mounting position of the actuator on the upper X-frame 240 also provides the benefit of the actuator 250 being closer to the controller and/or power source, which would allow for fewer or shortened harnesses and cables, etc. and therefor provides a more compact patient support 10.

The roller 230, 256 arrangement with the corresponding slots 234, 254 provides a stable horizontal position during the adjustment of the height of the patient support 10. Generally, such roller and slot arrangements are provided with one fixed “roller” or “pin” while the other is moveable within a slot. When one pin is fixed and is provided in combination with a roller, the deck may move from a horizontal orientation. In the embodiment shown in FIGS. 7-9, the rollers 230, 256 in slots 234, 254 in the lower housing 210 and top bracket 215 may travel along the length of the slots 234, 254 during raising and lowering of the lifting mechanism 200. The traveling of the rollers 230, 256 facilitates a smooth change in patient support 10 height while maintaining a horizontally even, unshifting deck 214. Lower and upper stabilizing members 236, 262 prevent the rollers 230, 256 from moving within the slots 234, 254 when the actuator 250 is not engaged to adjust the height of the patient support 10.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A patient support comprising:
a base;
a caster joined to said base, the caster having a substantially vertical swivel axis;
a wheel on the caster to facilitate rolling movement of the support; and
a brake link supported by said base and coupled to a linear actuator operable to provide mechanical braking to said wheel of said rolling movement and said caster of said swivel.

2. The patient support of claim 1 further comprising:
a brake rod extending transversely across said base and rotating about a brake rod axis.

3. The patient support of claim 1 further comprising said wheel having a rotational axis about which is provided said rolling movement.

4. The patient support of claim 3 further comprising:
two actuating members, a first member causing said caster to brake about said swivel axis and a second member causing said wheel to brake about its rotational axis.

5. The patient support of claim 4 wherein the two actuating members cause said caster and said wheel to brake simultaneously.

6. The patient support of claim 1 further comprising:
a deck;
a lifting mechanism having an upper end coupled to said deck and a lower end supported by said base, and said lifting mechanism having an upper component and a lower component; and
a lifting actuator joined to said upper component.

7. The patient support of claim 6 wherein said upper component is an upper X-frame and said lower component is a lower X-frame.

8. The patient support of claim 7 wherein said deck has a range of vertical movement between an upper deck height above a floor and a lower deck height above said floor, and said lower deck height is less than about 14 inches above said floor.

9. The patient support of claim 8 wherein said lower deck height is less than about 13 inches above said floor.

10. The patient support of claim 9 wherein said lower deck height is about 12 inches above said floor.

11. A patient support comprising:
a deck;
a base;
a lifting mechanism having an upper end coupled to said deck and a lower end supported by said base, and said lifting mechanism having an upper component and a lower component; and
a lifting actuator joined to said upper component.

12. The patient support of claim 11 wherein said upper component is an upper X-frame and said lower component is a lower X-frame and wherein said upper X-frame is stacked over and interconnected to said lower X-frame.

13. The patient support of claim 11 further comprising:
a frame of said deck having slots therein;
an upper roller coupled to said upper end; and
a lower roller coupled to said lower end of said lifting mechanism, said upper and lower rollers at least partially transversing the slots.

14. The patient support of claim 13:
wherein said deck has a range of vertical movement between an upper deck height above a floor and a lower deck height above said floor; and
wherein said rollers travel within said slots as said deck moves with said range of vertical movement.

15. The patient support of claim 14 wherein said travel of said rollers within said slots maintains said deck in a substantially horizontal position during a change of vertical position of said deck over said range of vertical movement.

16. The patient support of claim 15 further comprising:
an upper stabilizing member having a first end joined to said frame of said deck and a second end joined to said upper component; and
a lower stabilizing member having a first end joined to lower base of said lifting mechanism and a second end joined to said lower component.

17. The patient support of claim 16 wherein said lower deck height is less than about 14 inches.

18. The patient support of claim 17 wherein said lower deck height is about 12 inches.

19. The patient support of claim 16 further comprising:
a caster joined to said base, the caster having a substantially vertical swivel axis;
a wheel on the caster to facilitate rolling movement of the support; and
a brake link supported by said base and coupled to a linear actuator operable to provide mechanical braking to said wheel of said rolling movement and said caster of said swivel.

20. The patient support of claim 19 further comprising:
two actuating members, a first member causing said caster to brake about said swivel axis and a second member causing said wheel to brake about a rotational axis about which said wheel rotates.
